(19) United States
(12) Patent Application Publication
(10) Pub. No.: US 2022/0189341 A1
(43) Pub. Date: Jun. 16, 2022

(54) SURGICAL SUTURING, AND BOWEL ANASTOMOSIS TRAINING SIMULATOR

(71) Applicant: West Virginia University Board of Governors on Behalf of West Virginia University, Morgantown, WV (US)

(72) Inventor: Nova Szoka, Morgantown, WV (US)

(21) Appl. No.: 17/549,080

(22) Filed: Dec. 13, 2021

Related U.S. Application Data
(60) Provisional application No. 63/126,056, filed on Dec. 16, 2020.

(51) Int. Cl. G09B 23/28

(52) U.S. Cl. CPC G09B 23/28

(57) ABSTRACT

Embodiments of a surgical training device are provided for a simulated medical procedure on tissues. The surgical training device has first and second tissues supported on a generally planar stand. Each of the tissues has a longitudinal body with a peripheral wall surrounding an internal lumen and an elongated hole extending through the wall from the exterior of the body to the internal lumen. The peripheries of the holes of the first and second tissues are attached with sutures or staples, so that a preferably closed, fluid communicating throughway is established between the internal lumens of the first and second tissues, by performance of the simulated medical procedure. Furthermore, in this device, a fluid source provides fluid to the internal lumen of the first tissue so that fluid flows into the lumen of the first tissue, through the closed fluid communicating throughway, and into the lumen of the second tissue, thereby imposing fluid pressure in the fluid communicating throughway and against the attached first and second tissues. The sutures or staples, whichever is applicable, can be observed for a leak to indicate the efficacy of the simulated medical procedure.

### CLAIM OF PRIORITY

This application claims priority to and the benefit of U.S. Patent Application entitled “Surgical Suturing and Small Bowel Anastomosis Training Simulator (sb-ATS),” filed on Dec. 16, 2020, under application no. 63/126,056, which is incorporated herein by reference in its entirety.

### FIELD OF INVENTION

This application is generally related to surgical training devices, and in particular, to tissue structures and models for teaching and practicing surgical suturing and anastomosis procedures in open, laparoscopic, or robotic settings.

### BACKGROUND OF THE INVENTION

Medical students as well as experienced doctors learning new surgical techniques must undergo extensive training before they perform these procedures on patients. Traditionally, these skills have been developed by observing and assisting attending surgeons, practicing the techniques on animal tissue, and utilizing various surgical simulation techniques.

A surgical anastomosis procedure is a surgical technique used to make a new connection between two body structures that carry fluid, such as blood vessels or bowel. This procedure can be performed using hand-sewn sutures, mechanical stapling devices, and/or biological glues, depending on the circumstances.

Currently, most medical residents learn this technique either by doing so directly in an operating room under the supervision of an attending surgeon or by performing the procedure on an ex-vivo animal bowel in a simulation lab setting once per year. In each of these cases there is little opportunity for the learner to repeat the exercise multiple times and benefit from repetition of these surgical skills.

In view of the foregoing, at least one objective of this invention is to provide a surgical training device that realistically simulates anatomy, isolates such anatomy, and presents such an anatomy at a stage or step of a procedure that also enables repeatable practice.

Both U.S. patent application Ser. No. 12/941,446 to Marshall (2010), and U.S. patent application Ser. No. 14/036,129 to Breslin (2013) describe surgical training devices that can be used to perform suturing procedures on artificial tissues. The Breslin application describes its model as being useful to practice anastomosis procedures. Unfortunately, both the Marshall and Breslin applications describe devices that do not have the capacity to assess the integrity of the surgical closure. There is a need for an improved device to practice surgical procedures and testing to provide surgical trainees prompt and practical assessment of surgical skills.

### SUMMARY OF THE INVENTION

Embodiments of a surgical training device are provided that can be used to practice a medical procedure with a pressure test in open, laparoscopic, and robotic settings. The surgical training device includes one or more tissues (synthetic or biological) that are held by a holder such that the tissue or tissues are capable of being sutured or stapled. The device is suitable for practicing different types of anastomosis procedures, such as end-to-end or side-to-side anastomoses. A leak test is provided that involves flowing fluid through the completed anastomosis and observing the closure for any leaks that may develop. The pressure that develops during the leak test can be measured using a digital manometer that can be connected to one of the portions of tissue. This device provides a portable model that can be used by learners in a simulation lab or at home, allowing learners to develop advanced surgical skills in a setting outside the operating room.

One embodiment, among others, is a surgical training device for a simulated medical procedure on a tissue. The surgical training device has first and second tissues supported on a generally planar stand. Each of the tissues has a longitudinal body with a peripheral wall surrounding an internal lumen and an elongated hole extending through the wall from the exterior of the body to the internal lumen. The peripheries of the holes of the first and second tissues are attached with sutures or staples, so that a fluid communicating throughway is established between the internal lumens of the first and second tissues, by performance of the simulated medical procedure. Furthermore, in this device, a fluid source provides fluid to the internal lumen of the first tissue so that fluid flows into the lumen of the first tissue, through the closed fluid communicating throughway, and into the lumen of the second tissue, thereby imposing fluid pressure and stress in the fluid communicating throughway and against the attached (sutured or stapled) tissues. The sutures or staples, whichever is applicable, can be observed for a leak(s) to indicate an effectiveness of the simulated medical procedure. In another possible embodiment, a manometer is connected to the lumen of the second tissue and is used to measure the fluid pressure.

Another embodiment, among others, is a surgical training device for a tissue having a hole that is closed with sutures or staples, for form a closure, in accordance with the simulated medical procedure. The surgical training device includes a first stand supporting a proximal portion of the single tissue and a second stand supporting a distal portion of the single tissue. The second stand includes a clamp. A pressure testing mechanism is provided and comprises a fluid source in fluid communication with an internal lumen of the tissue, which imposes fluid pressure and stress against the closure. A base supports the first and the second stands. The foregoing surgical training device can be used to practice the simulated medical procedure.

Another embodiment, among others, is a method for performing a pressure test of a simulated medical procedure. The method can be summarized by the following steps: (a) providing first and second tissues on a holder, each of the tissues having a longitudinal body with a wall surrounding an internal lumen and a hole extending through the wall from the exterior of the body to the internal lumen; (b) performing the simulated medical procedure by attaching peripheries of the holes of the first and second tissues with sutures or staples, so that a closed fluid communicating throughway is established between the internal lumens of the first and second tissues; (c) providing fluid to the internal lumen of the first tissue after step (b) so that fluid flows into the lumen of the first tissue, through the closed throughway, and into the lumen of the second tissue, thereby imposing fluid pressure and stress in the fluid communicating throughway and against the attached (sutured or stapled) tissues; (d) determining an effectiveness of the simulated medical procedure by inspecting the sutures or staples, whichever is applicable, for a leak(s). In another possible embodiment, a manometer is connected to the lumen of the second tissue and is used to measure the fluid pressure.

Other embodiments, systems, apparatus, methods, features, and advantages of the present invention will be or become apparent to one with skill in the art upon examination of the following drawings and detailed description. It is intended that all such additional embodiments, systems, apparatus, methods, features, and advantages be included within this description, be within the scope of the present invention, and be protected by the accompanying claims.

### BRIEF DESCRIPTION OF THE DRAWINGS

Many embodiments and aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view of an embodiment of a surgical training device of the present disclosure for teaching and practicing surgical suturing and anastomosis procedures in open, laparoscopic, or robotic settings.

FIG. 2 is a perspective view of a second embodiment of the surgical training device of the present disclosure for teaching and practicing surgical suturing and anastomosis procedures in open, laparoscopic, or robotic settings.

FIG. 3 is a perspective view of an embodiment of the base with stands that is utilized in the surgical training devices of FIGS. 1 and 2.

### DETAILED DESCRIPTION OF EMBODIMENTS

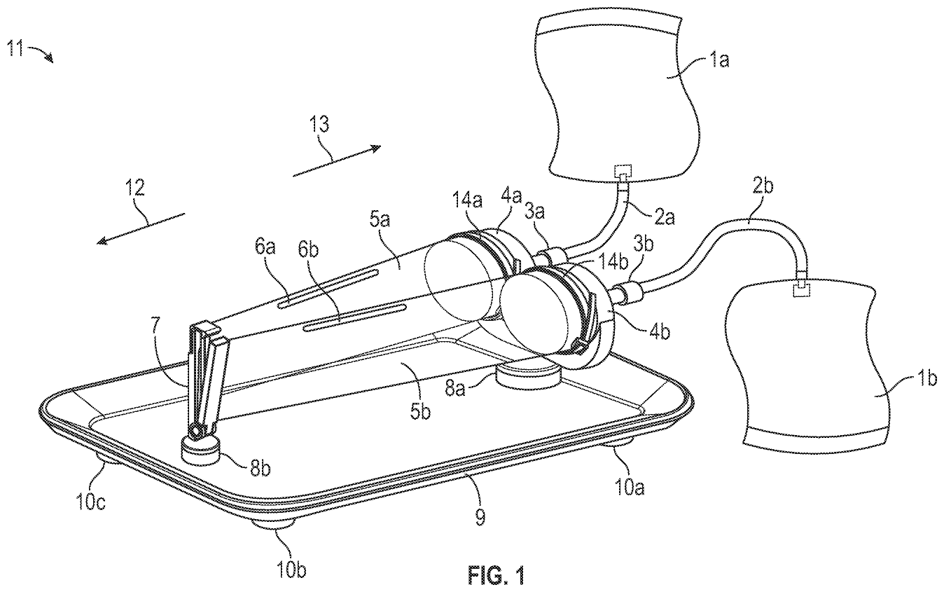

The present disclosure provides various embodiments of a surgical training device. FIG. 1 shows a first embodiment of a surgical training device 11, among others, that is configured to allow a user to perform a simulated anastomosis procedure using first and second artificial tissues 5a, 5b. An anastomosis procedure is a surgical technique used to make a new fluid connection between two body structures that carry fluid, such as blood vessels or bowel. For example, an arterial anastomosis is used in vascular bypass and a colonic anastomosis is used to restore colonic continuity after the resection of colon cancer.

The surgical training device 11 includes a proximal end 13 and a distal end 12 for the purpose of orientation. The surgical training device 11 has a tissue holder that includes a generally planar, tray-like base 9 made of a rigid plastic or other suitable rigid material. Optionally, but preferably, the tray-like base 9 has an attachment mechanism in the form of a plurality of suction cups 10a-10c (preferably 4 in number spaced as a rectangle; one is not shown) mounted to the base underside that allow the surgical training device 11 to be secured to an underlying surface. The surgical training device 11 has two circular upstanding stands, a proximal stand 8a and a distal stand 8b, which rise vertically from and are mounted to and made as a part of the base 9. The distal stand 8b has a clamp 7 mounted at its top. As shown, the clamp 7 is hinged at the bottom end and can be secured and unsecured at the top end, which has a locking mechanism. The stands 8a and 8b and the clamp 7 are made of plastic or similar rigid material.

A first artificial tissue 5a has an elongated hole 6a in the top central portion and a second artificial tissue 5b has the same or a similar elongated hole 6b in the top central portion. The artificial tissues 5a, 5b have the capacity to function in conjunction with different anastomosis techniques, including hand-sewn suturing, instrument assisted suturing, surgical stapling, in open laparoscopic, or robotic surgical settings.

The first and second artificial tissues 5a, 5b are generally tubular, each having a longitudinal body with a wall surrounding a central internal lumen, or throughway, for internal communication of fluid. The artificial tissues 5a, 5b are preferably made of silicone, but can made from any suitable elastomeric material that can be sutured or stapled, preferably repeatedly. The proximal ends of the first and second artificial tissues 5a, 5b are attached to a first and second generally cylindrical cuffs 4a, 4b, respectively, using a suitable attachment mechanism, for example, respective plastic cable ties 14a, 14b, which wrap around the outer surface of and secure the proximal ends of the tissues 5a, 5b against the outer surface of the respective cuffs 4a, 4b. The attachment mechanism should enable attachment (securing) and detachment (un-securing). The cuffs 4a, 4b are supported by stand 8a and are preferably made as a single unitary part made from rigid plastic or some other suitable rigid material.

The proximal portions of the tissues 5a, 5b can be attached to the respective cuffs 4a, 4b using attachment mechanisms other than cable ties. As a non-limiting example, the cable ties could be replaced with hose clamps, tubing clamps, circular clamps, etc.

At the proximal end 13 of the surgical training device 11 is a first bag 1a and a second bag 1b that are connected to a first tube 2a and a second tube 2b (or hose). The first tube 2a is connected to the opening 3a of the first cuff 4a and the second tube 2b is connected to the opening 3b of the second cuff 4b.

A surgical anastomosis procedure is practiced by suturing or stapling an elongated hole 6a in the first artificial tissue 5a (preferably located at the center of the top of the first artificial tissue 5a) to a similar elongated hole 6b of the second artificial tissue 5b. The holes 6a, 6b each extend through the tissue wall from the exterior of the tissue body to the internal lumen. More specifically, the peripheral edge of the hole 6a is sutured or stapled to the peripheral edge of the hole 6b so that a preferably closed, fluid communicating throughway is created between the lumen of the first artificial tissue 5a and the lumen of the second artificial tissue 5b. This surgical suturing or stapling can be performed in open, laparoscopic, or robotic surgical settings.

In essence, the surgical training device 11 includes a pressure tester in the form of a fluid source in communication with the internal lumens of the tissues 5a, 5b In order to check the efficacy or integrity of the surgical closure with sutures or staples. A fluid, for example but not limited to, water, can be added from a preferably raised first bag 1a, can flow through the connected first and second tissues 5a and 5b of the surgical training device 11, and ultimately drain into the preferably lowered second bag 1b. Leaks and/or fluid flow will be apparent as the fluid passes through the system and applies pressure to the walls of the tissues 5a, 5b.

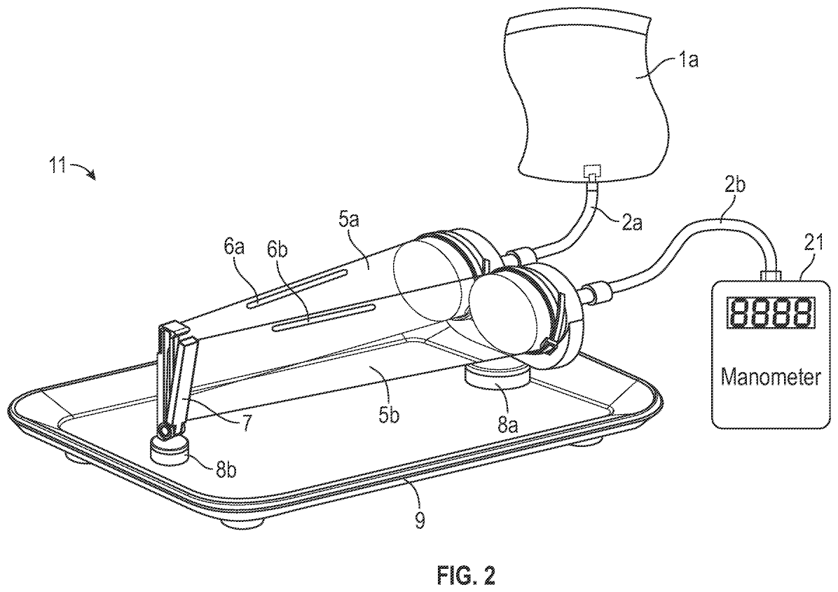

FIG. 2 shows a second embodiment of a surgical training device 11 that is configured to allow a user to perform a simulated anastomosis procedure. As illustrated, in this embodiment, the bag 1b is replaced with a manometer 21, which is a conventional device for measuring fluid pressures. The nanometer 21 is attached to the tube 2b and is in fluid communication with the second artificial tissue 5b. Any leak pressure can be measured using the manometer 21. The manometer 21 can provide a digital display of the real-time pressure, providing a quantification of the pressure being applied to the surgical closure by the fluid within the surgical training device 11. This allows a user to determine the amount of pressure that the user's surgical closure can withstand by noting the pressure value at the point fluid leaks are detected visually.

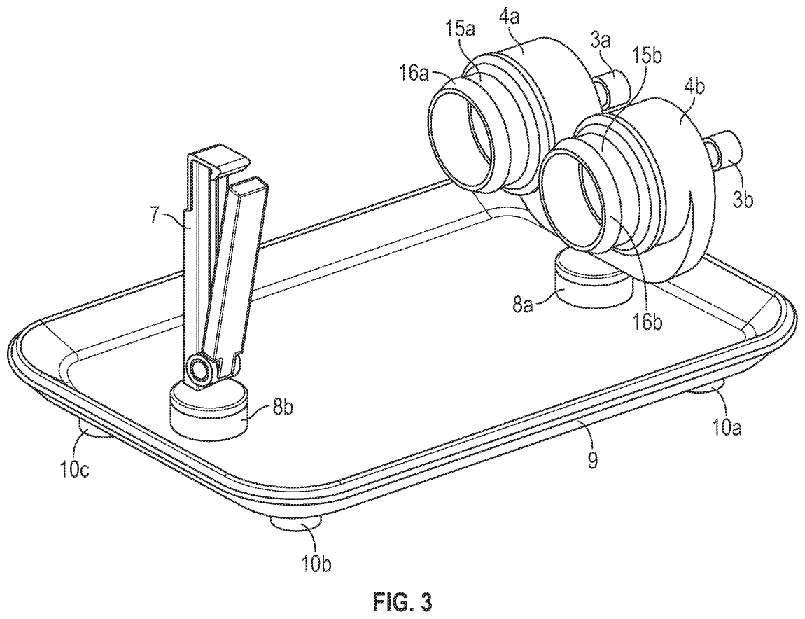

FIG. 3 is a perspective view of an embodiment of the base 9 with stands 8a, 8b that can be utilized in the surgical training devices of FIGS. 1 and 2. The first stand 8a supports the cuffs 4a, 4b, which along with the respective cable ties 14a, 14b secures proximal portions 13 of the tissues 5a, 5b. The second stand 8b supports the clamp 7, which secures and un-secures the distal portions 12 of the tissues 5a, 5b. The cuffs 4a, 4b have respective circumferential channels 15a, 15b for receiving the respective cable ties 14a, 14b and, furthermore, respective tapered tissue receiving ends 116a, 16b for accommodating tissues 5a 5b with different lumen diameters.

It should be noted that in all of the foregoing embodiments, the artificial tissues 5a, 5b can be replaced with actual human or animal biological tissues (e.g., bowel tissue, etc.).

Furthermore, the surgical training device 11 can be used within a laparoscopic or robotic simulator system for the purpose of performing a simulated surgical procedure.

It should be emphasized that the above-described embodiments of the present invention, particularly, any “preferred” embodiments, are merely possible nonlimiting examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention.

As an example of a variation, the surgical training device 11 can be implemented with only the first artificial tissue 5a (and not with the second artificial tissue 5b). In this embodiment, the user can practice closing a hole with sutures or staples, and the success of the surgical closure can be tested by the introduction of fluid into the tissue 5a. A manometer 21 can optionally be employed to measure pressure. It can be interfaced using a T-connection so that it is in fluid communication with the tube 2a, for example, in order to measure pressure.

As another example of a variation, sources of pressurized fluid other than from the elevated bag 1a could be employed in the surgical training device 11.

Therefore, at least the following is claimed:

1. A surgical training device for a simulated medical procedure on a tissue, comprising:
first and second tissues supported on a generally planar stand, each of the tissues having a longitudinal body with a peripheral wall surrounding an internal lumen and an elongated hole extending through the wall from the exterior of the body to the internal lumen;
wherein peripheries of the holes of the first and second tissues are attached with sutures or staples, so that a fluid communicating throughway is established between the internal lumens of the first and second tissues, by performance of the simulated medical procedure;
a fluid source that provides fluid to the internal lumen of the first tissue so that fluid flows into the lumen of the first tissue, through the fluid communicating throughway, and into the lumen of the second tissue, thereby imposing fluid pressure in the fluid communicating throughway and against the attached first and second tissues;
whereby the sutures or staples, whichever is applicable, can be observed for a leak to indicate an effectiveness of the simulated medical procedure.

2. The device of claim 1, further comprising a manometer connected in fluid communication with the lumen of the second tissue, the manometer measuring the fluid pressure.

3. The device of claim 1, further comprising:
first and second stands mounted to the base, the second stand supporting both distal portions of the first and second tissues;
first securing means for detachably securing the distal portions of the first and second tissues to the second stand;
first and second cuffs supported by the first stand, the first and second cuffs supporting proximal portions of the first and second tissues respectively;
second securing means for detachably securing the proximal portion of the first tissue to the first cuff; and
third securing means for detachably securing the proximal portion of the second tissue to the second cuff.

4. The device of claim 3, wherein the first securing means comprises a clamp mounted on the second stand that clamps and unclamps both distal portions of the first and second tissues and a means for attaching and wherein the second and third securing means are each a cable tie.

5. The device of claim 1, wherein the first and second tissues are tubular.

6. The device of claim 1, wherein the first and second tissues are made of an elastomeric material.

7. The device of claim 1, wherein the first and second tissues are artificial or actual biological tissues.

8. The device of claim 1, wherein the base further comprises a plurality of suction cups situated at its underside and designed to secure the base to an underlying surface.

9. A surgical training device for practicing a simulated medical procedure on a tissue, comprising:
a first stand supporting a proximal portion of the tissue;
a first securing means for detachably securing the proximal portion of the tissue to and from the first stand;
a second stand supporting a distal portion of the tissue;
a second securing means for detachably securing the distal portion of the tissue to and from the second stand;
wherein the tissue has a hole that is closed with sutures or staples to form a closure in accordance with the simulated medical procedure;
a pressure testing means comprising a fluid source in fluid communication with an internal lumen of the tissue to thereby impose fluid pressure against the closure; and
a base supporting the stands.

10. The device of claim 9, wherein the device contains a second tissue, a third stand supporting the proximal portion of the second tissue; and third securing means for detachably securing the proximal portion of the second tissue to the third stand.

11. The device of claim 10, wherein the tissue and the second tissue have a tubular form and are comprised of an artificial elastomeric material.

12. The device of claim 11, wherein the first and third securing means are cable ties.

13. The device of claim 12, wherein the second securing means comprises a clamp designed to clamp in order to secure and unclamp to unsecure both distal portions of the tissue and second tissue.

14. The device of claim 13, wherein the pressure testing means further comprises:
a bag containing the fluid source;
a tube in communication with the fluid source and the internal lumen of the tissue; and
a manometer in fluid communication with the bag and fluid source, the manometer measuring the fluid pressure imposed against the closure,
whereby a pressure test can be performed to test the efficacy of the simulated medical procedure.

15. The device of claim 14, wherein the simulated medical procedure comprises suturing or stapling.

16. The device of claim 9, wherein the simulated medical procedure can be performed with an open technique, a laparoscopic technique, or a robotic technique.

17. The device of claim 9, wherein the simulated medical procedure is an anastomosis procedure.

18. The device of claim 9, wherein the base contains a plurality of suction cups situated at its underside that secure the base to an underlying surface.

19. A method for performing a simulated medical procedure, comprising the steps of:
(a) providing first and second tissues on a holder, each of the tissues having a longitudinal body with a wall surrounding an internal lumen and a hole extending through the wall from the exterior of the body to the internal lumen;
(b) performing the simulated medical procedure by attaching peripheries of the holes of the first and second tissues with sutures or staples, so that a fluid communicating throughway is established between the internal lumens of the first and second tissues;
(c) providing fluid to the internal lumen of the first tissue after step (b) so that fluid flows into the lumen of the first tissue, through the fluid communicating throughway, and into the lumen of the second tissue, thereby imposing fluid pressure in the fluid communicating throughway and against the attached first and second tissues; and
(d) determining an effectiveness of the simulated medical procedure by inspecting the sutures or staples, whichever is applicable, for a leak.

20. The method of claim 19, further comprising the step of connecting a manometer to the lumen of the second tissue and measuring pressure generated against the lumens of the tissues with the manometer.
